(19) United States
(12) Patent Application Publication
(10) Pub. No.: US 2009/0119422 A1
(43) Pub. Date: May 7, 2009

(54) METHOD AND APPARATUS FOR PERFORMING MAINTENANCE OPERATIONS ON PERIPHERAL DEVICES

(75) Inventors: Shreyas Abhay Kale, Morrisville, NC (US); William White, JR., Raleigh, NC (US); Robert Dean Yoder, Cary, NC (US)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 11/936,367

(22) Filed: Nov. 7, 2007

(51) Int. Cl. G06F 13/12

(52) U.S. Cl. 710/10

(57) ABSTRACT

The illustrative embodiments described herein provide a computer implemented method, apparatus, and computer program product for performing maintenance operations on a first set of peripheral devices. The method initiates communication to the first set of peripheral devices using a radio frequency transmission link. A set of diagnostic routines is initiated on the first set of peripheral devices. Data associated with the diagnostic routines from the first set of peripheral devices is received. A number of maintenance updates from a plurality of maintenance updates is selected for each peripheral device in the first set of peripheral devices using the data associated with the set of diagnostic routines. Maintenance operations are performed simultaneously, over the radio frequency transmission link, for each peripheral device in the first set of peripheral devices utilizing the number of maintenance updates.

### BACKGROUND OF THE INVENTION

1. Field of the Invention

The present invention relates generally to an improved data processing system and method for performing maintenance on peripheral devices. Still more particularly, the present invention relates to a computer implemented method, apparatus, and computer program product for performing maintenance operations on peripheral devices using a radio frequency transmission link.

2. Description of the Related Art

The modern office environment typically includes multiple computer workstations, with each workstation or group of workstations assigned to a nearby printer. It often falls to members of an information systems staff or other computer support staff to maintain not only the workstations, but the peripheral equipment including printers. In some cases, these printers may be accessible on a network, either directly or indirectly, via connecting workstations. These connections allow a network administrator to update printer resident software and/or firmware and perform other maintenance checks, tests, and functions. However, not all printers are accessible via a network nor are all functions necessarily accessible.

Additionally, when a peripheral device, such as a printer, requires diagnostic operations to be performed, a data processing system associated with the peripheral device is required to be “taken over” for the diagnostics to be run. This process usually involves booting the system from a universal serial bus (USB) device or a bootable diskette. These actions result in an increase in time associated with each service call. Furthermore, the process depends on the system unit functioning for the diagnostics to be run.

Current methods exist for performing local maintenance of a computer peripheral using a portable device. However, the current methods are limited by the fact that an individual is required to travel to each individual peripheral device, hold and point the portable device directly at the peripheral device, wait for diagnostic routines to be ran, and then wait for updates to be performed. This type of process is time consuming especially in an environment when multiple peripherals require updates.

### SUMMARY OF THE INVENTION

The illustrative embodiments described herein provide a computer implemented method, apparatus, and computer program product for performing maintenance operations on a first set of peripheral devices. The method initiates communication to the first set of peripheral devices using a radio frequency transmission link. A set of diagnostic routines is initiated on the first set of peripheral devices. Data associated with the diagnostic routines from the first set of peripheral devices is received. A number of maintenance updates from a plurality of maintenance updates is selected for each peripheral device in the first set of peripheral devices using the data associated with the set of diagnostic routines. Maintenance operations are performed simultaneously, over the radio frequency transmission link, for each peripheral device in the first set of peripheral devices utilizing the number of maintenance updates.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates an environment comprising of data processing systems and peripheral devices in which illustrative embodiments may be implemented;

FIG. 2 illustrates a diagram of a data processing system in accordance with an illustrative embodiment of the present invention;

FIG. 3 is a block diagram depicting components of a peripheral device in which illustrative embodiments may be implemented;

FIG. 4 is a block diagram depicting components of a software application for performing maintenance operations on peripheral devices in accordance with an illustrative embodiment;

FIG. 5 is a flowchart illustrating a process for updating a first set of peripheral devices in accordance with an illustrative embodiment; and

FIGS. 6A and 6B is a flowchart illustrating a process for updating a second set of peripheral devices in accordance with an illustrative embodiment.

### DETAILED DESCRIPTION OF THE PREFERRED EMBODIMENT

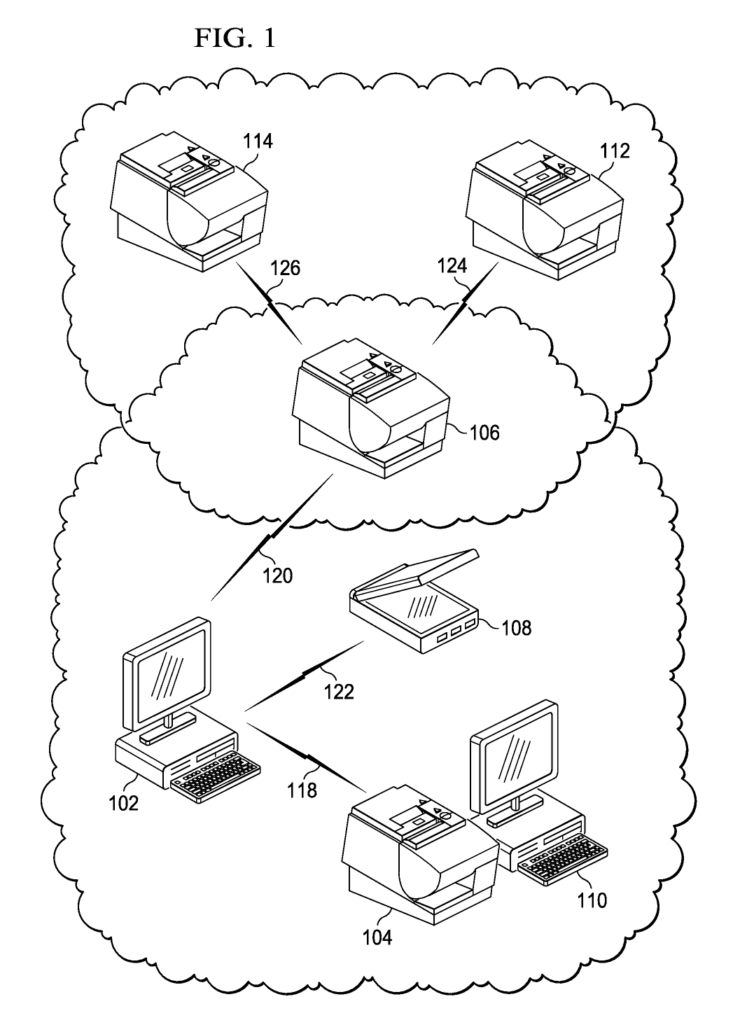

With reference now to the figures, and in particular with reference to FIGS. 1-3, exemplary diagrams of data processing environments are provided in which illustrative embodiments may be implemented. It should be appreciated that FIGS. 1-3 are only exemplary and are not intended to assert or imply any limitation with regard to the environments in which different embodiments may be implemented. Many modifications to the depicted environments may be made.

FIG. 1 illustrates an environment comprising of data processing systems and peripheral devices in which illustrative embodiments may be implemented. Data processing system 102 is a data processing system in which embodiments may be implemented. Data processing system 102 communicates to peripheral devices, such as, but not limited to, printers, scanners, fax machines, and copiers.

In the depicted example, data processing system 102 communicates to peripheral devices 104, 106, and 108 over communication links 118, 120, and 122, respectively. Communication links 118, 120, 122, 124, and 126 utilize a radio frequency transmission link. In this example, the Bluetooth protocol is used as the communication protocol for the radio frequency transmission link. The range associated with the radio frequency may vary from 1 meter, to 10 meters, and even up to 100 meters. Data processing system 102 and peripheral devices 104, 106, 108, 112, and 114 each contain Bluetooth enabled hardware. Alternatively, data processing system 102 or peripheral devices 104, 106, 108, 112, and 114 are coupled to a Bluetooth enabled adapter that supports Bluetooth communication.

Additionally, the peripheral devices may be coupled to a data processing system, such as data processing system 110 and peripheral device 104, or may be a stand alone peripheral device, such as peripheral devices 106 and 114. Data processing system 102 and peripheral devices 104, 106, 108, 112, and 114 may include other types of connections, such as wire, wireless communication links, and/or fiber optic cables.

In the depicted example, data processing system 102 and peripheral devices 104, 106, and 108 form a piconet. In these examples, a piconet is a collection of devices connected via Bluetooth technology in an ad hoc fashion. A piconet starts with two connected devices, such as, for example, data processing system 102 and peripheral device 104. A piconet has a limit number of devices, such as 8 devices in the illustrative examples. All Bluetooth devices are peer units and have identical implementations. However, when establishing a piconet, one unit acts as a master for synchronization purposes, and the other unit(s) will be slave(s) for the duration of the piconet connection. In the depicted example, data processing system 102 acts as the master and peripheral devices 104, 106, and 108 are slaves of to data processing system 102.

A second piconet is illustrated in FIG. 1, in which peripheral device 106 acts as a master and communicates with peripheral devices 112 and 114 over communication links 124 and 126, respectively. Communication between the first piconet and second piconet can be accomplished through a common device of both piconets, such as peripheral device 106. Communication between the first piconet and second piconet forms a scatternet.

A scatternet is two or more independent and non-synchronized piconets that communicate with each other. A slave, as well as a master unit, in one piconet can establish this connection by becoming a slave or a master in the other piconet. The common device shared by the piconets relays communications between the piconets, if the need arises. FIG. 1 is intended as an example, and not as an architectural limitation for different embodiments.

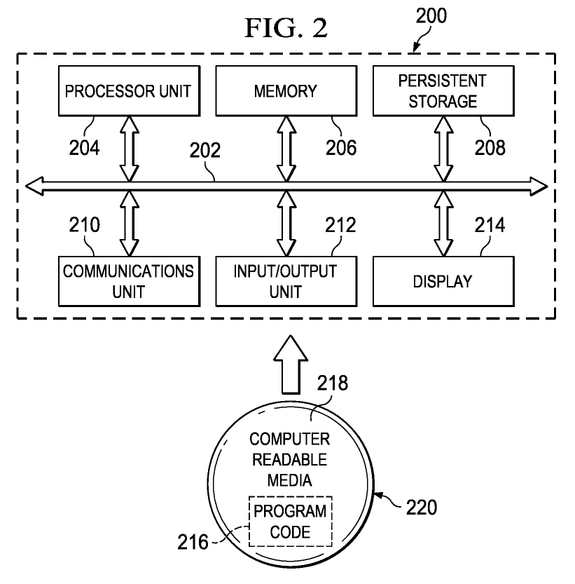

Turning now to FIG. 2, a diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208 and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

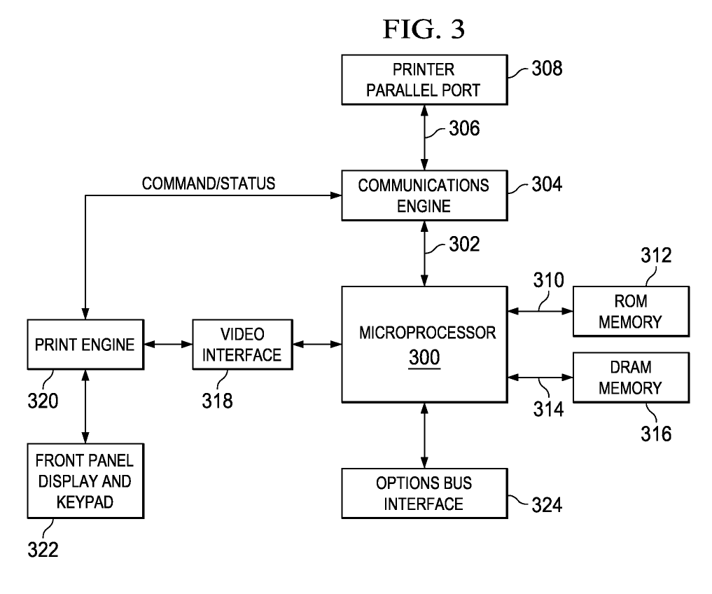

With reference now to FIG. 3, a block diagram depicting components of a peripheral device is presented in which illustrative embodiments may be implemented. In this example, the peripheral device is a printer. The printer comprises of microprocessor 300 coupled to communications engine 304 by means of bus 302. The microprocessor may be, but is not limited to, a reduced instruction set computer (RISC) processor for controlling the operation of the peripheral device. Communications engine 304 is coupled to printer parallel port 308 via bus 306. A ROM memory 312 is connected to the processor via bus 310 for the loading of operational control instructions into the microprocessor 300. A dynamic random access memory (DRAM) memory 316 is also connected, via bus 314, to the microprocessor 300 for the storage of print-files to be printed by the printer as well as diagnostic software as will be further described below. DRAM memory 316 may, for example, be a 4 MB memory unit, and may be expanded with the installation of additional memory devices. A print engine video interface 318 couples microprocessor 300 to print engine 320 which executes the printing function of the printer under control of the communications engine 304. A front panel display and keypad 322 is located on the outside of the printer and is coupled through print engine 320 and communications engine 304 to the microprocessor 300. An options bus interface 324 is also coupled to microprocessor 300 and enables the connection of additional interface cards for various options useable with the printer.

The hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-3 and above-described examples are not meant to imply architectural limitations. For example, data processing system 200 also may be a tablet computer, laptop computer, or telephone device in addition to taking the form of a PDA.

The illustrative embodiments provide a computer implemented method for performing maintenance operations on peripheral devices, such as peripheral devices 104, 106, 108, 112, and 116 as depicted in FIG. 1. Maintenance operations may include, but are not limited to, the performance of diagnostic routines on the peripheral devices and the process of updating software/firmware associated with the peripheral devices. A data processing system, such as data processing system 102 as depicted in FIG. 1, initiates communication to a first set of peripheral devices, such as peripheral devices 104, 106, and 108, using a radio frequency transmission link. Data processing system 102 may be a desktop, a laptop, a tablet computer, a PDA, or any other form of a computing device. Diagnostic routines are initiated on the first set of peripheral devices. The data processing system receives data associated with the diagnostic routines from the first set of peripheral devices. The data processing system selects a number of maintenance updates for each peripheral device in the first set of peripheral devices from a plurality of maintenance updates using the data associated with the diagnostic routines. The number of maintenance updates may include one or more maintenance updates. Maintenance operations are performed simultaneously, over the radio frequency transmission link, for each peripheral device in the first set of peripheral devices utilizing the number of maintenance updates.

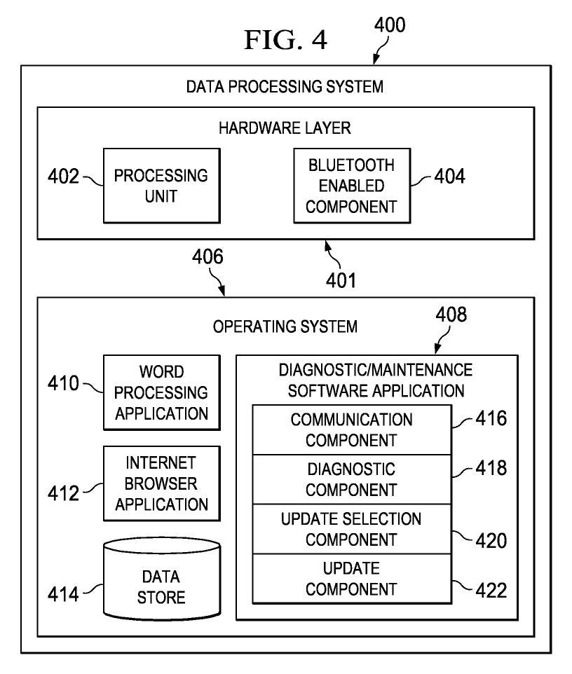

With reference now to FIG. 4, a block diagram depicting components of a software application for performing maintenance operations on peripheral devices is presented in which illustrative embodiments may be implemented. Data processing system 400 may be implemented in a data processing system, such as a data processing system 102 as shown in FIG. 1, or data processing system 200 as shown in FIG. 2.

Data processing system 400 includes hardware layer 401. The hardware layer comprises of at least processing unit 402 and a Bluetooth enabled component 404. Bluetooth enabled component 404 may be an embedded chip on the system board of data processing system 400, or may be a Bluetooth enabled device coupled to the system board, such as a PCI/PCIe component. Alternatively, Bluetooth enabled component 404 may be an external adapter coupled to a port of data processing system 400, such as a universal serial bus port.

Operating system 406 runs on data processing system 400. Operating system 406 may be a commercially available operating system such as, but not limited to, Microsoft® Windows® Vista®. The illustrative embodiments may be implemented in a diagnostic/maintenance software application 408 running on operating system 406. Operating system 406 may run other software applications, such as, but not limited to, a word processing application 410 and an Internet browser application 412.

Diagnostic/maintenance software application 408 communicates to a data store containing software and firmware updates, such as data store 414. Data store 414 may be an internal database, such as Microsoft® SQL Server®, installed on data processing system 400. Microsoft® SQL Server® is a relational database management system (RDBMS) and is a trademark of Microsoft Corporation. Alternatively, data store 414 may be a remote data store installed on a separate data processing system and is accessed by data processing system 400.

In this example, diagnostic/maintenance software application 408 contains communication component 416, diagnostic component 418, update selection component 420, and update component 422. Communication component 416 initiates communication with the Bluetooth enabled peripheral devices. In order to establish new connections, the inquiry and paging procedures are used. The inquiry procedure enables a unit to discover which units are in range, and what their device addresses and clocks are. With the paging procedure, an actual connection can be established. Only the Bluetooth device address is required to set up a connection. Knowledge about the clock will accelerate the setup procedure. A unit that establishes a connection will carry out a page procedure and will automatically become the master of the piconet.

Diagnostic component 418 initiates diagnostic routines on the peripheral devices. Diagnostic routines consist of a series of instructions executed by the processing unit within the peripheral devices. The diagnostic routines test and report on the operational status or functionality of components within the peripheral devices. One status reported by the diagnostic routines may be, but is not limited to, the current version of software and firmware installed on the peripheral devices. The results of the diagnostic routines are received by data processing system 400.

Update selection component 420 uses the data received from the peripheral devices to select applicable maintenance updates for each peripheral device from a data store of updates, such as data store 414. Update component 422 transmits the applicable updates to each peripheral device and initiates installation of the updates on the peripheral devices. Diagnostic component 418 may initiate diagnostic routines on the peripheral devices after installation of the updates to ensure proper functionality of the peripheral devices.

Diagnostic/maintenance software application 408 may contain other components not illustrated in FIG. 4 or the components illustrated in FIG. 4 may be combined or omitted in other embodiments. Additionally, in another illustrative embodiment, diagnostic/maintenance software application 408 is installed on a peripheral device. The peripheral device acts as the master of a piconet and performs maintenance operations on other peripheral devices within the piconet.

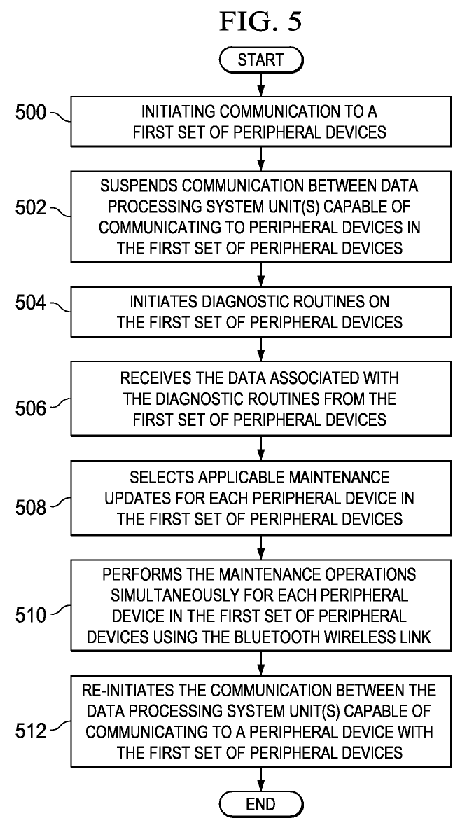

With reference now to FIG. 5, a flowchart illustrating a process for updating a first set of peripheral devices is depicted in accordance with an illustrative embodiment. The process of FIG. 5 may be implemented in a software application, such as diagnostic/maintenance software application 408 depicted FIG. 4.

The process begins by initiating communication to a first set of peripheral devices using a radio frequency (step 500). In this example, the Bluetooth protocol is used as the communication protocol for the radio frequency transmission link. The Bluetooth protocol supports both point-to-point and point-to-multi-point connections.

In these examples, the first set of peripheral devices may be one or more peripheral devices up to seven different peripheral devices to form a piconet. The connection procedure for a non-existent piconet is initiated by any of the devices, such as data processing system 400 as depicted in FIG. 4. The initiating device then becomes master of the created piconet. When a connection is established, the process suspends communication between any data processing system unit(s) capable of communicating to a peripheral device in the first set of peripheral devices, such as data processing system 110 and peripheral device 108 in FIG. 1 (step 502).

The process initiates diagnostic routines on the first set of peripheral devices (step 504). The first set of peripheral devices performs the diagnostic routines and transmits the results to the master device. The process receives the data associated with the diagnostic routines from the first set of peripheral devices (step 506). Data may include, but is not limited to, error codes, software and firmware versions, and diagnostic performance results.

The process then selects a number of applicable maintenance updates for each peripheral device in the first set of peripheral devices from a plurality of maintenance updates using the data associated with the diagnostic routines (step 508). The maintenance updates may be stored in a data store, such as data store 414 depicted in FIG. 4. The applicable maintenance updates may be different for each peripheral device in the first set of peripheral devices.

The process performs the maintenance operations simultaneously, over the radio frequency transmission link, for each peripheral device in the first set of peripheral devices utilizing the number of maintenance updates (step 510). The process re-initiates the communication, previously suspended in step 502, between the data processing system unit(s) capable of communicating to a peripheral device with the first set of peripheral devices (step 512), with the process terminating thereafter.

The process for performing the maintenance operations includes sending the applicable maintenance updates and initializing installation of the maintenance updates on each peripheral device. In another illustrative embodiment, the process initiates diagnostic routines on the first set of peripheral devices after performing the installation of the applicable maintenance updates to ensure proper functionality of the peripheral devices.

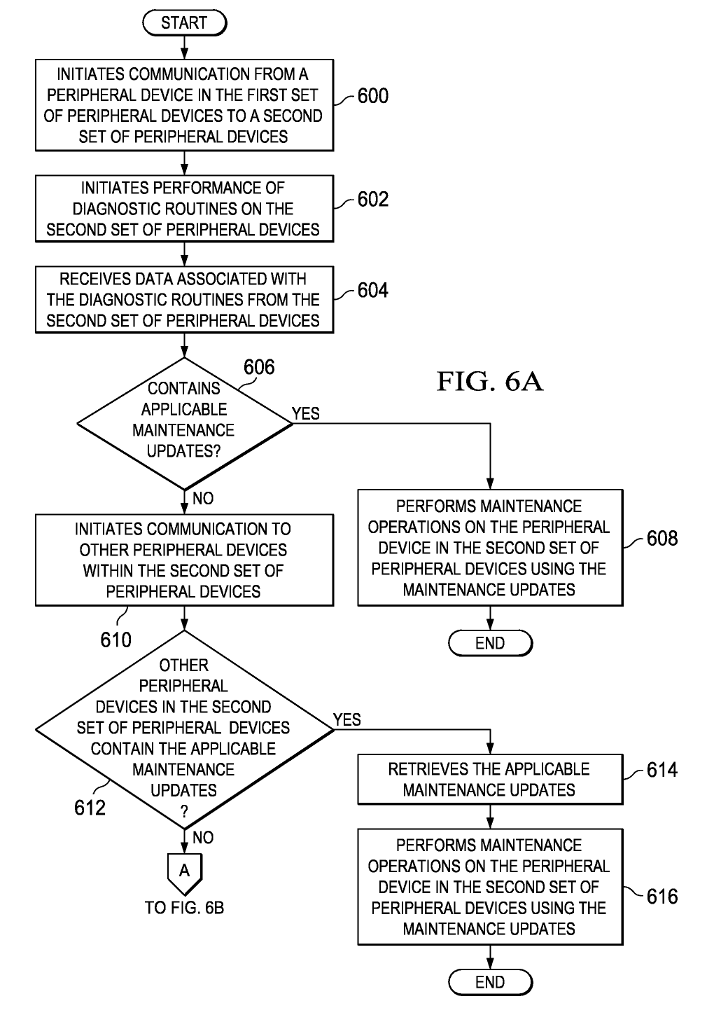

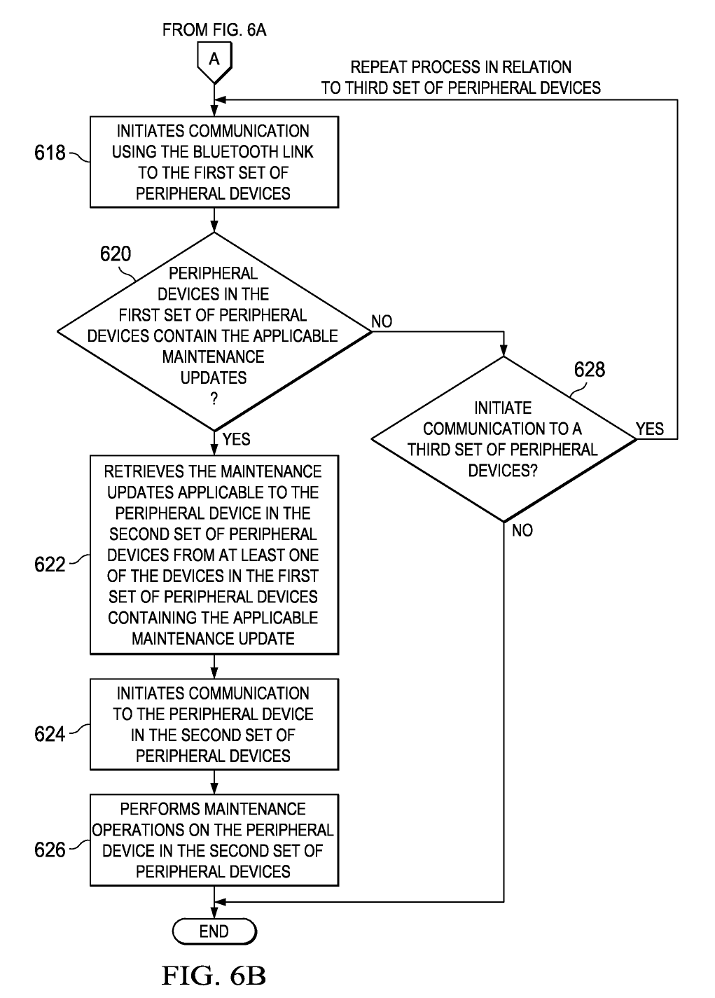

With reference now to FIGS. 6A and 6B, a flowchart illustrating a process for updating a second set of peripheral devices is presented in accordance with an illustrative embodiment. The process in FIGS. 6A and 6B may be implemented in a software application, such as diagnostic/maintenance software application 408 depicted FIG. 4, executed on a peripheral device.

The process begins by initiating communication from a peripheral device, such as peripheral device 106, in the first set of peripheral devices to a second set of peripheral devices using a radio frequency transmission link (step 600). The peripheral device in the first set of peripheral devices becomes the master device of a second piconet in which the peripheral devices in the second set of peripheral devices are slaves of the piconet. The second set of peripheral devices may contain one or more peripheral devices. The process initiates performance of diagnostic routines on the second set of peripheral devices (step 602). The process receives data associated with the diagnostic routines from the second set of peripheral devices (step 604). The process then determines if the peripheral device, on which the process is being executed, contains maintenance updates applicable to the peripheral devices in the second set of peripheral devices (step 606). Following a determination that the peripheral device in the first set of peripheral devices contains maintenance updates applicable to a peripheral device in the second set of peripheral devices, the peripheral device in the first set of peripheral devices performs maintenance operations on the peripheral device in the second set of peripheral devices utilizing the maintenance updates (step 608), with the process terminating thereafter.

However, in response to a determination, at step 606, that the peripheral device in the first set of peripheral devices does not contain the maintenance updates applicable to a peripheral device in the second set of peripheral devices, the process initiates communication to other peripheral devices within the second set of peripheral devices using the radio frequency transmission link (step 610). The process requests maintenance updates applicable to the peripheral device in the second set of peripheral devices from the other peripheral devices in the second set of peripheral devices (step 612). Responsive to a determination that at least one of the other peripheral devices in the second set of peripheral devices contains the maintenance updates applicable to the peripheral device in the second set of peripheral devices, the process retrieves the maintenance updates applicable to the peripheral device in the second set of peripheral devices from the at least one other peripheral device (step 614). The process performs maintenance operations on the peripheral device in the second set of peripheral devices utilizing the applicable maintenance updates (step 616), with the process terminating thereafter.

If a determination is made that the other peripheral devices in the second set of peripheral devices does not contain the maintenance updates applicable to the peripheral device in the second set of peripheral devices, the process initiates communication using the radio frequency transmission link to the first set of peripheral devices (step 618).

The peripheral device in the first set of peripheral devices may become the master of the piconet for first set of peripheral devices or may remain a slave of the piconet for the first set of peripheral devices. The first set of peripheral devices may include a data processing system containing maintenance updates, such as data processing system 102 shown in FIG. 1.

The process determines if at least one of the peripheral devices in the first set of peripheral devices contains the maintenance updates applicable to the peripheral device in the second set of peripheral devices (step 620). Following a determination that at least one of the peripheral devices in the first set of peripheral devices contains the maintenance updates applicable to the peripheral device in the second set of peripheral devices, the process retrieves the maintenance updates applicable to the peripheral device in the second set of peripheral devices from at least one of the devices in the first set of peripheral devices containing the applicable maintenance update (step 622). The process then initiates communication, using the radio frequency transmission link, to the peripheral device in the second set of peripheral devices (step 624). The process performs maintenance operations on the peripheral device in the second set of peripheral devices (step 626), with the process terminating thereafter.

If the process does not locate the applicable maintenance updates in the first set of peripheral devices, at step 620, the process determines if a communication link can be initiated with a third set of peripheral devices (step 628). If a communication link can be initiated to a third set of peripheral devices, the process initiates communication with the third set of peripheral devices and repeats steps 618-624 in relation to the third set of peripheral devices. If at step 628, a communication link cannot be initiated with a third set of peripheral devices, the process terminates.

Thus, the illustrative embodiments described herein provide a computer implemented method, apparatus, and computer program product for performing maintenance operations on a first set of peripheral devices. The method initiates communication to the first set of peripheral devices using a radio frequency transmission link. A set of diagnostic routines is initiated on the first set of peripheral devices. Data associated with the diagnostic routines from the first set of peripheral devices is received. A number of maintenance updates from a plurality of maintenance updates is selected for each peripheral device in the first set of peripheral devices using the data associated with the set of diagnostic routines. Maintenance operations are performed simultaneously, over the radio frequency transmission link, for each peripheral device in the first set of peripheral devices utilizing the number of maintenance updates.

Furthermore, the illustrative embodiments provide a method for a peripheral device within the first set of peripheral devices to update a second set of peripheral devices. Therefore, the illustrative embodiments provide a method for dynamically performing maintenance operations on multiple peripheral devices at the same time; thus, reducing the amount of man-hours required to maintain peripheral devices. In addition, the illustrative embodiments provide a method for performing maintenance operations on peripheral devices without requiring “taking over” the data processing system coupled to the peripheral device to perform diagnostic and maintenance routines.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for performing maintenance operations on a first set of peripheral devices, the computer implemented method comprising:
initiating communication to the first set of peripheral devices using a radio frequency transmission link;
initiating a set of diagnostic routines on the first set of peripheral devices;
responsive to the set of diagnostic routines being performed on the first set of peripheral devices, receiving data associated with the diagnostic routines from the first set of peripheral devices;
selecting a number of maintenance updates from a plurality of maintenance updates for each peripheral device in the first set of peripheral devices using the data associated with the set of diagnostic routines; and
performing maintenance operations simultaneously for each peripheral device in the first set of peripheral devices utilizing the number of maintenance updates.

2. The computer implemented method of claim 1, wherein initiating communication to the first set of peripheral devices is performed by a device out of a line of sight with the first set of peripheral devices.

3. The computer implemented method of claim 1, wherein performing maintenance operations comprises:
sending the number of maintenance updates to the first set of peripheral devices over the radio frequency transmission link; and
initiating installation of the set of maintenance updates on the first set of peripheral devices.

4. The computer implemented method of claim 1, further comprising:
suspending communication between a set of data processing system units and a peripheral device in the first set of peripheral devices prior to initiating the set of diagnostic routines.

5. The computer implemented method of claim 4, further comprising:
initiating communication between the set of data processing system units and the peripheral device in the first set of peripheral devices after the set of maintenance updates on the peripheral device is performed.

6. The computer implemented method of claim 1, wherein a data processing system unit coupled to a peripheral device among the first set of peripheral devices is not powered on during the computer implemented method of claim 1.

7. The computer implemented method of claim 1, further comprising:
initiating communication from a peripheral device in the first set of peripheral devices to a second set of peripheral devices using the radio frequency transmission link;
initiating the second set of peripheral devices to perform a set of diagnostic routines;
responsive to the set of diagnostic routines being performed on the second set of peripheral devices, receiving data associated with the set of diagnostic routines from the second set of peripheral devices;
determining if the peripheral device in the first set of peripheral devices contains maintenance updates applicable to peripheral devices in the second set of peripheral devices; and
responsive to a determination that the peripheral device in the first set of peripheral devices contains maintenance updates applicable to a peripheral device in the second set of peripheral devices, performing maintenance operations on the peripheral device in the second set of peripheral devices utilizing the maintenance updates, wherein the maintenance operations are performed by the peripheral device in the first set of peripheral devices.

8. The computer implemented method of claim 7, further comprising:
responsive to a determination that the peripheral device in the first set of peripheral devices does not contain maintenance updates applicable to the peripheral device in the second set of peripheral devices, initiating communication to other peripheral devices using the radio frequency transmission link;
determining if the other peripheral devices contains maintenance updates applicable to the peripheral device in the second set of peripheral devices;
responsive to a determination that at least one peripheral device in the other peripheral devices contains the maintenance updates applicable to the peripheral device in the second set of peripheral devices, retrieving the maintenance updates applicable to the peripheral device in the second set of peripheral devices from the at least one peripheral device; and
performing maintenance operations on the peripheral device in the second set of peripheral devices utilizing the maintenance updates, wherein the maintenance operations are performed by the peripheral device in the first set of peripheral devices.

9. The computer implemented method of claim 8, wherein performing the maintenance operations comprises:
sending the maintenance updates to the peripheral device in the second set of peripheral devices over the wireless link; and
initiating installation of the maintenance updates on the peripheral device in the second set of peripheral devices.

10. The computer implemented method of claim 1 wherein the first set of peripheral devices comprises of at least two or more peripheral devices.

11. A computer program product comprising:
a computer usable medium including computer usable program code for performing maintenance operations on a first set of peripheral devices, the computer program product comprising:
computer usable program code for initiating communication to the first set of peripheral devices using a radio frequency transmission link;
computer usable program code for initiating a set of diagnostic routines on the first set of peripheral devices;
computer usable program code for receiving data associated with the diagnostic routines from the first set of peripheral devices in response to the set of diagnostic routines being performed on the first set of peripheral devices;
computer usable program code for selecting a number of maintenance updates from a plurality of maintenance updates for each peripheral device in the first set of peripheral devices using the data associated with the set of diagnostic routines; and
computer usable program code for performing maintenance operations simultaneously for each peripheral device in the first set of peripheral devices utilizing the number of maintenance updates.

12. The computer program product of claim 11 wherein the computer usable program code for initiating communication to the first set of peripheral devices is performed by a device out of a line of sight with the first set of peripheral devices.

13. The computer program product of claim 11, further comprising:
computer usable program code for suspending communication between a set of data processing system units and a peripheral device in the first set of peripheral devices prior to initiating the set of diagnostic routines.

14. The computer program product of claim 13, further comprising:
computer usable program code for initiating communication between the set of data processing system units and the peripheral device in the first set of peripheral devices after the set of maintenance updates on the peripheral device is performed.

15. The computer program product of claim 11, wherein a data processing system unit coupled to a peripheral device among the first set of peripheral devices is not powered on during the computer implemented method of claim 1.

16. The computer program product of claim 11, further comprising:
computer usable program code for initiating communication from a peripheral device in the first set of peripheral devices to a second set of peripheral devices using the radio frequency transmission link;
computer usable program code for initiating the second set of peripheral devices to perform a set of diagnostic routines;
computer usable program code for receiving data associated with the set of diagnostic routines from the second set of peripheral devices in response to the set of diagnostic routines being performed on the second set of peripheral devices;
computer usable program code for determining if the peripheral device in the first set of peripheral devices contains maintenance updates applicable to peripheral devices in the second set of peripheral devices; and
computer usable program code for performing maintenance operations on the peripheral device in the second set of peripheral devices utilizing the maintenance updates, wherein the maintenance operations are performed by the peripheral device in the first set of peripheral devices in response to a determination that the peripheral device in the first set of peripheral devices contains maintenance updates applicable to a peripheral device in the second set of peripheral devices.

17. The computer program product of claim 16, further comprising:
computer usable program code for initiating communication to other peripheral devices using the radio frequency transmission link in response to a determination that the peripheral device in the first set of peripheral devices does not contain maintenance updates applicable to the peripheral device in the second set of peripheral devices;
computer usable program code for determining if the other peripheral devices contains maintenance updates applicable to the peripheral device in the second set of peripheral devices;
computer usable program code for retrieving the maintenance updates applicable to the peripheral device in the second set of peripheral devices from the at least one peripheral device in response to a determination that at least one peripheral device in the other peripheral devices contains the maintenance updates applicable to the peripheral device in the second set of peripheral devices; and
computer usable program code for performing maintenance operations on the peripheral device in the second set of peripheral devices utilizing the maintenance updates, wherein the maintenance operations are performed by the peripheral device in the first set of peripheral devices.

18. The computer program product of claim 17, wherein the computer usable program code for performing maintenance operations comprises:
computer usable program code for sending the maintenance updates to the peripheral device in the second set of peripheral devices over the wireless link; and
computer usable program code for initiating installation of the maintenance updates on the peripheral device in the second set of peripheral devices.

19. The computer program product of claim 11 wherein the first set of peripheral devices comprises of at least two or more peripheral devices.

20. An apparatus comprising:
a bus system;
a communications system connected to the bus system;
a memory connected to the bus system, wherein the memory includes computer usable program code; and a processing unit connected to the bus system, wherein the processing unit executes the computer usable program code to initiate communication to the first set of peripheral devices using a radio frequency transmission link; initiate a set of diagnostic routines on the first set of peripheral devices; receive data associated with the diagnostic routines from the first set of peripheral devices in response to the set of diagnostic routines being performed on the first set of peripheral devices; select a number of maintenance updates from a plurality of maintenance updates for each peripheral device in the first set of peripheral devices using the data associated with the set of diagnostic routines; and perform maintenance operations simultaneously for each peripheral device in the first set of peripheral devices utilizing the number of maintenance updates.
